(19) United States
(12) Patent Application Publication
(10) Pub. No.: US 2023/0109808 A1
(43) Pub. Date: Apr. 13, 2023

(54) MULTILAYER SURFACING FILM

(71) Applicant: 3M Innovative Properties Company, St. Paul, MN (US)

(72) Inventors: Ryan E. MARX, Rosemount, MN (US); Lisha ZHANG, Guangzhuo (CN)

(21) Appl. No.: 18/046,187

(22) Filed: Oct. 13, 2022

Related U.S. Application Data
(60) Provisional application No. 63/255,065, filed on Oct. 13, 2021.

(51) Int. Cl. C08J 7/04; C08J 5/24

(52) U.S. Cl. CPC C08J 7/042; C08J 5/24; C08J 2375/04; C08J 2327/18; C08J 2327/20; C08J 2327/16

(57) ABSTRACT

Provided is a multilayer film that includes a top layer and a barrier layer. The top layer includes a polyurethane network and having an exposed major surface. The barrier layer includes a fluoropolymer and having opposed first and second major surfaces, where the first major surface is modified by a surface treatment and wherein the top layer is disposed on the first major surface. When bonding to a curable substrate, the barrier layer can prevent migration of low molecular weight species from the curable substrate into the polyurethane network, thereby avoiding discoloration resulting from exposure of these species to ultraviolet light and other weathering factors.

### FIELD OF THE INVENTION

This disclosure relates to surfacing films, and in particular, multilayer surfacing films that can be used to protect curable substrates such as fiber-reinforced prepregs.

### BACKGROUND

The following references may be relevant to the general field of technology of the present disclosure: U.S. Pat. No. 4,302,553 (Frisch et al); U.S. Pat. No. 4,859,742 (Pattein et al); U.S. Pat. No. 4,948,859 (Echols et al); U.S. Pat. No. 5,959,775 (Joseph et al); U.S. Pat. No. 6,623,824 (Joseph et al); U.S. Pat. No. 7,713,604 (Yang et al); U.S. Pat. No. 8,096,508 (Marx et al); U.S. Pat. No. 8,668,166 (Rawlings et al); U.S. Pat. No. 8,916,271 (Marx at el); and U.S. Pat. No. 9,352,533 (Rawlings et al).

U.S. Pat. No. 6,623,824, “Method for Making a Microreplicated Article Using a Substrate Comprising a Syndiotactic Vinyl Aromatic Polymer,” purports to describe a “urethane acrylate IPN formulation,” for example, in Examples 14, 15, C1, 20, and 21. The term “IPN” is used there in a manner inconsistent with the manner in which it is used in the present application. Each “urethane acrylate IPN formulation” of U.S. Pat. No. 6,623,824, Examples 14, 15, C1, 20, and 21 includes caprolactone acrylate, a monomer having a hydroxy group reactive with polyurethane-forming (polyisocyanate) monomers at one end, and an acrylate group reactive with polyacrylate-forming monomers at the other. Therefore, it is believed that upon heat cure of the polyurethane-forming and polyacrylate-forming monomers of the “urethane acrylate IPN formulation,” one single polymer network is formed.

Damage caused by sand and rain erosion is a significant problem for outdoor structures subject to adverse environmental conditions. This can be especially problematic for exterior aircraft components. Airfoil surfaces, such as leading edges of wings, stabilizers, helicopter rotor blades, engine propellers, and engine fan blades, are susceptible to significant erosion caused by sand and rain when made from fiber reinforced composite materials. Composite parts used in these areas are usually protected from erosion damage with films, tapes, or coatings, often made of elastomeric polyurethane which is a material known to provide erosion resistance.

### SUMMARY

Composite parts can be protected by bonding to its surface a polyurethane network, such as a semi-interpenetrating polymer network (or semi-IPN) film that combines a thermoplastic polyurethane and a crosslinked polyurethane acrylate oligomer. Exterior surfacing films made from crosslinked polyurethanes can provide a high degree of protection with substantial erosion resistance and processibility. These films can be advantageously bonded to composite parts with a curable adhesive after the part has been formed or can be co-cured with the part to which it is bonded. In a co-cured configuration, a curing resin in a pre-impregnated composite (or prepreg) bonds to the semi-IPN polyurethane film during the curing process. This curing process is often carried out at elevated temperatures and pressures.

When curing prepregs, however, it was discovered that the elevated temperature and pressure can cause low molecular weight species in the prepreg, such as amine and epoxy monomers, to migrate into the polyurethane film. The migration of these low molecular weight species degrades resistance to ultraviolet (UV) light, resulting in a surface that can discolor when exposed to the environment and solar radiation. For applications in which these co-curable urethane films are to be used on external aircraft surfaces, there is a need for a urethane protective film that provides all of the same benefits as with the current films, but with improved UV resistance.

To overcome this problem, a barrier layer can be integrated into the polyurethane film. Fluoropolymers have low permeability and excellent chemical resistance, making them excellent barrier layers. However, fluoropolymers inherently have a low surface energy, thus bonding to the polyurethane to make a multilayer film can be challenging. This can be overcome by employing a nanostructured plasma treatment to the surface of the fluoropolymer film which results in a high bond strength to the polyurethane film. The surfacing films described herein can bond strongly to the prepreg during the curing process, withstand the curing temperatures, and display sufficient flexibility and dead stretch performance that it can be applied to curved or complex surfaces without cracking.

In a first aspect, a multilayer film is provided. The multilayer film comprises: a top layer comprising a polyurethane network and having an exposed major surface; a barrier layer comprising a fluoropolymer and having opposed first and second major surfaces, wherein the first major surface is modified by a surface treatment and wherein the top layer is disposed on the first major surface.

In a second aspect, a composite assembly is provided, comprising: a top layer having an exposed major surface and comprising a polyurethane network; a barrier layer comprising a fluoropolymer and having opposed first and second major surfaces, wherein the first major surface is modified by a surface treatment; and a substrate, wherein the first major surface of the barrier layer faces the top layer and the second major surface of the barrier layer faces the substrate.

In a third aspect, a method of making a multilayer film is provided, comprising: modifying a first major surface of a barrier layer comprising a fluoropolymer; and coating a curable polyurethane onto the first major surface; and curing the curable polyurethane.

In a fourth aspect, a method of protecting a curable substrate is provided, comprising: disposing the multilayer film on the curable substrate; and curing the curable substrate, wherein the barrier layer substantially reduces migration of low-molecular weight compounds from the curable substrate to the top layer of the multilayer film over time.

### BRIEF DESCRIPTION OF THE DRAWINGS

FIG. 1 is a side elevational view of a multilayer film according to an exemplary embodiment; and

FIGS. 2 and 3 are side elevational views of bonded assemblies incorporating multilayer films according to exemplary embodiments.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### Definitions

As used herein:

“height” means, with regard to a nanostructured surface, the greatest difference in elevation of the surface measured along an axis orthogonal to the general plane of the nanostructured layer in the vicinity of the nanostructure, e.g., in a ridge-and-valley pattern, the difference between the ridge peak and valley bottom;

“interpenetrating polymer network” (or “IPN”) means a material comprising two or more polymer networks which are at least partially interlaced on a molecular scale but not covalently bonded to each other and cannot be separated unless chemical bonds are broken;

“semi-interpenetrating polymer network” or “semi-IPN” means a material comprising at least one polymer network and at least one linear or branched polymer, not covalently bonded to each other, characterized by the penetration on a molecular scale of the network by the linear or branched polymer;

“urea acrylate oligomer” means a polyurea oligomer having polymerizable acrylate end groups;

“urea acrylate polymer network” means a polymer network comprising polyurea segments and polyacrylate segments, including a polymer network obtained by polymerizing the acrylate end groups of one or more urea acrylate oligomers;

“urethane acrylate oligomer” means a polyurethane oligomer having polymerizable acrylate end groups;

“urethane acrylate polymer network” means a polymer network comprising polyurethane segments and polyacrylate segments, including a polymer network obtained by polymerizing the acrylate end groups of one or more urethane acrylate oligomers; “urethane/urea acrylate oligomer” means a polyurethane/polyurea oligomer having polymerizable acrylate end groups; and

“urethane/urea acrylate polymer network” means a polymer network comprising polyurethane/polyurea segments and polyacrylate segments, including a polymer network obtained by polymerizing the acrylate end groups of one or more urethane/urea acrylate oligomers.

### DETAILED DESCRIPTION

As used herein, the terms “preferred” and “preferably” refer to embodiments described herein that may afford certain benefits under certain circumstances. However, other embodiments may also be preferred, under the same or other circumstances. Furthermore, the recitation of one or more preferred embodiments does not imply that other embodiments are not useful, and other embodiments are not excluded from the scope of the invention.

As used herein and in the appended claims, the singular forms “a,” “an,” and “the” include plural referents unless the context clearly dictates otherwise. Thus, for example, reference to “a” or “the” component can include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,” “an,” “the,” “at least one,” and “one or more” are used interchangeably herein.

Relative terms such as left, right, forward, rearward, top, bottom, side, upper, lower, horizontal, and vertical can be used herein and, if so, are from the perspective observed in the particular figure. These terms are used only to simplify the description, however, and not to limit the scope of the invention in any way. Figures are not necessarily to scale.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

### Surfacing Films

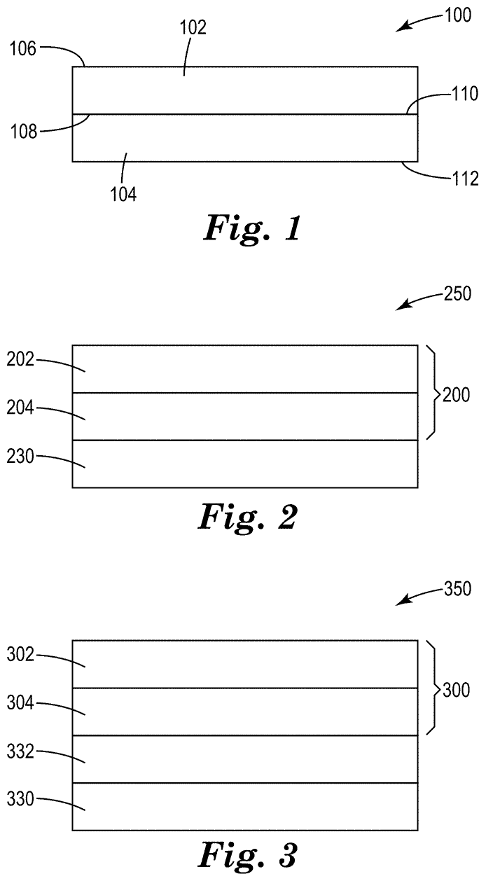

A surfacing film according to one exemplary embodiment is illustrated in FIG. 1 and herein designated by the numeral 100. As shown, the film 100 has a layered construction, comprised of a top layer 102 and a barrier layer 104. The top layer 102 is comprised of a polyurethane network. In various embodiments, the polyurethane network can be an interpenetrating network. Details of useful polyurethane network compositions can be found in the subsection below entitled “Polyurethane networks.” The barrier layer 104 is made from a fluoropolymer, a class of materials whose details are further described in the subsection below entitled “Fluoropolymers.”

The top layer 102 has a first major surface 106 exposed at the top of the film 100 and a second major surface 108 that directly contacts the barrier layer 104. Likewise, the barrier layer 104 has opposing first and second major surfaces 110, 112, where the first major surface 110 faces the top layer 102 and the second major surface 112 is exposed at the bottom of the film 100. Optionally and as shown, the top layer 102 and barrier layer 104 are mutually coextensive.

The first major surface 110 of the barrier layer 104 is modified by a surface treatment that facilitates adhesion between the barrier layer 104 and the top layer 102. Absent such surface treatment, achieving strong adhesion to a barrier layer comprised of a fluoropolymer can be a significant technical challenge. In a preferred embodiment, adhesion between the top layer 102 and the barrier layer 104 is enhanced by providing the first major surface 110 of the barrier layer 104 with a nanostructured surface. In some embodiments, the nanostructured surface includes a multiplicity of topological features, each having a height to width (or average width) ratio of at least 1.5:1, at least 2:1, at least 3:1, at least 4:1, or at least 5:1. In some applications, it can be advantageous to apply the same or different surface treatment on the second major surface 112 of the barrier layer 104 to enhance adhesion at the barrier layer/substrate interface.

The nanostructured surface enables permeation or interpenetration of the top layer 102 into the nanostructured surface of the barrier layer 104 where these layers come together. The nanostructured surface can further include undercut features that provide mechanical retention along the interface between the barrier layer 104 and the top layer 102. By causing one layer to be at least partially embedded in the other, or mutually interlocked, the nanostructured surface enables the layers of the film 100 to resist de-lamination.

In some embodiments, plasma reactive ion etching is used to provide a nanostructured surface on the fluoropolymer surface of the barrier layer 104. Plasma is a partially ionized gaseous or fluid state of matter containing electrons, ions, neutral molecules, and free radicals. Reactive ion etching can be carried out using any of a number of methods. One exemplary method uses a rotatable cylindrical electrode known as a drum electrode and a grounded counter-electrode within a vacuum vessel. The counter-electrode can be comprised of the vacuum vessel itself. Gas comprising an etchant can be introduced into the vacuum vessel, and plasma ignited and sustained between the drum electrode and the grounded counter-electrode. The conditions can be selected so that sufficient ion bombardment is directed perpendicular to the circumference of the drum. A continuous substrate comprising a nanoscale mask can then be wrapped around the circumference of the drum and the matrix can be etched in the direction normal to the plane of the article. The exposure time of the article can be controlled to obtain a predetermined etch depth of the resulting nanostructure.

Further improvement to adhesion between a fluoropolymer and a nonfluorinated polymer layer, such as the top layer 102, can be achieved by surface treatment followed by applying a layer of a second material such as a thermoplastic polyamide, such as described in U.S. Pat. No. 6,074,719 (Fukushi et al.). The nanostructured surface on the first major surface 110 enables a fluoropolymer barrier layer 104 to be securely coupled to the top layer 102 without need for an adhesive. The absence of an interlayer adhesive in turn enables a film 100 that can be made thinner and simpler in construction.

The top layer 102 can have any suitable thickness appropriate for the intended application of the film 100. Preferably, the film 100 should be capable of stretching as needed to conform to the shapes of curved substrates without damage to the film 100. The thickness of the top layer 102 can be from 4 micrometers to 1024 micrometers, from 75 micrometers to 500 micrometers, from 100 micrometers to 150 micrometers, or in some embodiments, less than, equal to, or more than 4 micrometers, 5, 6, 7, 8, 9, 10, 12, 14, 16, 18, 20, 25, 30, 35, 40, 45, 50, 60, 70, 80, 90, 100, 120, 140, 160, 180, 200, 250, 300, 350, 400, 450, 500, 550, 600, 650, 700, 750, 800, 850, 900, 950, 1000, or 1024 micrometers.

The barrier layer 104 can have any suitable thickness sufficient to prevent significant transmission of small molecular compounds, even at elevated temperatures. In prepreg applications, it is common for such molecular compounds to include, for example, unreacted amines and epoxy monomers. Useful thicknesses of the barrier layer 104 can be from 25 micrometers to 100 micrometers, or in some embodiments, less than, equal to, or more than 25 micrometers, 30, 35, 40, 45, 50, 55, 60, 65, 70, 75, 80, 85, 90, 95, or 100 micrometers.

FIG. 2 shows a bonded film assembly 250 according to an exemplary embodiment, showing a film 200 is directly bonded to an underlying substrate 230. The film 200, which includes a top layer 202 and a barrier layer 204, is essentially analogous to the film 100 described previously with respect to FIG. 1 and thus details thereof shall not be repeated here. The substrate 230 can be comprised of any useful substrate, including a curable substrate. Optionally, but not shown, an additional layer such as a tie layers or primers can be interposed between the film 200 and the substrate 230. In a preferred embodiment, the film 200 and the substrate 230 directly contact each other.

Particular technical benefits can be obtained when the film 200 is bonded to a curable substrate. The barrier layer 204 prevents the undesirable migration of reactive compounds from the curable substrate to the exposed major surface of the top layer 202. Reactive compounds can include unreacted monomers and curing agents. It is often the case that these chemical compounds are unstable when exposed to solar radiation, particularly UV, and other weathering factors in outdoor environments, which can lead to visible yellowing of the film 200. Further details about the substrates are described below in a subsection entitled “Substrates.”

Optionally and as shown, the film 200 and substrate 230 directly contact each other. This layer configuration can be advantageous when the substrate 230 is curable substrate containing a curable resin, typically an epoxy resin. In these cases, a permanent bond between the film 200 and substrate 230 can be formed during the manufacture of the film assembly 250, where the curable resin responsible for curing the substrate 230 also bonds effectively to the polyurethane film. This configuration can be used when applying the film 200 to a prepreg. In various embodiments, the prepreg is a fiber-reinforced prepreg, such as a carbon fiber-reinforced prepreg.

FIG. 3 shows a bonded film assembly 350 bearing similarities to the bonded film assembly 250 but further including an adhesive layer 332 between a film 300 and substrate 330. Other aspects of the film 300, including those of its constituent top layer 302 and barrier layer 304, are generally analogous to those already discussed.

The adhesive layer 332 can be made from any of a number of structural adhesives known in the art. Useful structural adhesives include curable one-part or two-part adhesives. Curable adhesives can include epoxy resins (a mixture of epoxide resin and curing agent), acrylates, cyano-acrylates, and urethanes. In a preferred embodiment, the curable adhesive is a dimensionally-stable one-part adhesive that can be easily integrated with a film, such as film 300, and applied to a substrate, where it can be subsequently cured by heat or by actinic radiation. Suitable adhesives are described in more detail in U.S. Patent Publication No. 2019/0389176 (Hebert et al.).

### Polyurethane Networks

In various embodiments, the top layer can comprise a crosslinked polyurethane, crosslinked polyurea, or crosslinked mixed polyurethane/polyurea polymer. Suitable polyurethanes include polymers of polyisocyanates and polyols. Suitable polyureas can include polymers of polyisocyanates and polyamines. In some embodiments, the crosslinked polymer may be a mixed polyurethane/polyurea polymer derived from polyisocyanates and a mixture of polyols and polyamines.

Suitable polyisocyanates can include aromatic isocyanates, aliphatic isocyanates, polyisocyanates, or combinations thereof. Suitable aromatic isocyanates can include methylene diphenyl diisocyanate, 1,4-phenylene diisocyanate, 1,3-phenylene diisocyanate, 3,3′-dimethyl diphenylmethane-4,4′-diisocyanate, diphenylmethane-2,2′-diisocyanate, naphthalene diisocyanate, 4,4′-biphenyldiisocyanate, 1,5-naphthalene diisocyanate, 2-methyl-1,5-naphthalene diisocyanate, 2,4-toluene diisocyanate and 2,6-toluene diisocyanate and mixtures of the two isomers, diphenylmethane-2,4′-diisocyanate, 4-ethyl-m-phenylenediisocyanate, or mixtures thereof. Suitable aliphatic isocyanates can include 2,4,4-Trimethylhexamethylene diisocyanate, 2,2,4-Trimethylhexamethylene diisocyanate, 1,4-cyclohexane diisocyanate, 1,3-cyclohexyl diisocyanate, trimethylhexamethylene diisocyanate, isophorone diisocyanate (IPDI), decamethylene diisocyanate, methylene diisocyanate, methylene-bis(4-cyclohexylisocyanate) (H12MDI), dimethyl diisocyanate, trans-1,4-cyclohexane diisocyanate, hexamethylene diisocyanate, or mixtures thereof Other suitable isocyanates can include polyisocyanates, including those based on any of the above. Of the aforementioned isocyanates, aliphatic isocyanates can be preferred based on their ultraviolet stability.

Suitable polyols can include polyester polyols, polycaprolactone polyols, polyether polyols, hydroxyl terminated polybutadiene and hydrogenated polybutadiene polyols, polycarbonate polyols, or mixtures thereof. Suitable polyamines can include polyetheramines sold under the trade designation JEFFAMINE, or mixtures thereof. In addition, chain extenders may be included, which are typically monomeric or low molecular weight difunctional compounds. Suitable hydroxy chain extenders can include ethylene glycol, diethylene glycol, propylene glycol, dipropylene glycol, neopentyl glycol, 1,4 butanediol, and 2-methyl-1,3-propylenediol, or mixtures thereof. Suitable amino chain extenders can include 1,4 diaminobutane, ethylenediamine, 1,2 diaminopropane, 1,3 diaminopropane, 1,2 diaminocyclohexane, isophorone diamine, secondary cycloaliphatic diamines, diethyltoluenediamine, or mixtures thereof.

In some embodiments, the crosslinked polymer may additionally comprise an acrylate component. The acrylate component is derived from any suitable acrylate component precursor, which is any suitable monomer, oligomer or polymer with an acrylate double bond available for polymerization. In some embodiments, acrylate component precursors are crosslinked by e-beam or other radiation during formation of the film to form the acrylate component ultimately present in the bonded film assembly.

In some embodiments, the acrylate component precursor is copolymerized into the polyurethane or polyurea prior to crosslinking of the acrylate component precursor. Suitable acrylates of this type include one or more groups which polymerize with the polyurethane or polyurea, such as alcohol or amine groups, and one or more acrylate double bonds available for polymerization. Other suitable species can include caprolactone acrylates, hydroxyethyl acrylate, dipentaerythritol pentaacrylate, or mixtures thereof.

In some embodiments, the acrylate component precursor is blended with the polyurethane or polyurea prior to crosslinking of the acrylate component precursor. In this embodiment, the polyurethane or polyurea forms a semi-interpenetrating polymer network with the crosslinked acrylate component in the final surfacing film or tape. A semi-interpenetrating polymer network is obtained where the acrylate-containing component is crosslinked and the other polyurethane or polyurea is not. Suitable acrylates include those sold by Arkema, S.A., Columbes, France under the trade designations CN996 and CN9893. Useful acrylates can be at least partially miscible in the polyurethane or polyurea.

The crosslinked polymer may be crosslinked by any suitable means, including radiation crosslinking, such as by e-beam, UV, visible light, infrared light, or covalent crosslinking achieved by the inclusion of crosslinking agents or polyfunctional monomers in the polymer during manufacture. Polyfunctional monomers can include polyisocyanates, polyols, polyamines, or mixtures thereof.

It can be further advantageous for the polyurethane network to include a UV stabilizer. Useful UV stabilizers include UV light absorbers and hindered-amine light stabilizers sold under the trade designation TINUVIN by BASF SE, Ludwigshafen, Germany. The combination of using a barrier layer and incorporating a UV stabilizer in the top layer can provide substantial weathering resistance to the overall composite film assembly.

The tape or film is typically transparent or translucent but may also be pigmented. The tape may have any suitable thickness. A typical thickness can be between 0.01 mm to 3.0 mm, from 0.01 mm to 1.0 mm, from 0.1 mm to 1.0 mm, from 0.25 mm to 1.0 mm, from 0.25 mm to 0.75 mm, or in some embodiments, less than, equal to, or greater than 0.01 mm, 0.02, 0.05, 0.07, 0.1, 0.2, 0.25, 0.3, 0.4, 0.5, 0.6, 0.7, 0.8, 0.9, 1, 1.2, 1.5, 1.7, 2, 2.5, or 3 mm.

### Fluoropolymers

Fluoropolymers include fluoroelastomers and fluoroplastics. Advantageously, these polymers tend to have high thermal stability and usefulness at high temperatures, and extreme toughness and flexibility at very low temperatures. Many of these polymers can be fully insoluble in a wide variety of organic solvents. See, for example F. W. Billmeyer, Textbook of Polymer Science, 3rd ed., pp. 398-403, John Wiley & Sons, New York (1984).

Useful fluoropolymers can be prepared from a variety of fluorinated and non-fluorinated monomers, including perfluorocycloalkene, ethylene ethane, vinyl fluoride (fluoroethylene), vinylidene fluoride (1,1-difluoroethylene), tetrafluoroethylene, chlorotrifluoroethylene, propylene, hexafluoropropylene, perfluoropropylvinylether, perfluoromethylvinylether, ethylene tetrafluoroethylene, poly(methyl methacrylate), and combinations thereof.

In some embodiments, the top layer 102 is made from a homopolymer of poly(vinylidene fluoride). In some embodiments, the top layer 102 is made from a copolymer of vinylidene fluoride and hexafluoropropylene. In some embodiments, the top layer 102 is made from a copolymer of tetrafluoroethylene, hexafluoropropylene, and vinylidene fluoride, such as sold under the trade designation THV from 3M Company, St. Paul, Minn. In some embodiments, the top layer 102 can be made from a THV/polyurethane interpenetrated network, as described in U.S. Patent Publication No. 2016/0237298 (Jing et al.).

### Substrates

The use of fiber reinforced resin matrix or fiber reinforced plastic (FRP) matrix composite laminates have become widely accepted for the variety of applications in aerospace, automotive and other transportation industries because their light weight, high strength and stiffness. Weight reduction benefits and performance enhancements are the biggest drivers behind implementation of fiber reinforced resin matrix composite laminates into industrial applications. Various airspace components being manufactured from fiberglass and carbon fibers reinforced composites including airplane fuselage sections and wing structures. Composites are used to fabricate many parts for airplanes, wind generators, automobiles, sporting goods, furniture, buses, trucks, boats, train cars and other applications where stiff, light-weight materials, or consolidation of parts are beneficial. Most often the fibers are made of carbon, glass, ceramic or aramid, and the resin matrix is an organic thermosetting or thermoplastic material. These parts are typically manufactured under vacuum and/or pressure at temperatures from 0° C. to 180° C., and sometimes up to 230° C. In some embodiments a film or tape according to the present disclosure may be adhered to such a composite part.

In some embodiments a film or tape according to the present disclosure may be used to line a mold used to form a part, such that after the molding process the resulting part has an outer surface of the film or tape. In some embodiments such a part is a composite part. Any suitable molding process may be used, including molding of polymers, composites, and fiberglass. The present disclosure includes a molded part having an outer layer which includes in whole or in part a film or tape according to the present disclosure. The molded part may be of any suitable molded material, including thermoplastic polymers, thermoset polymers, curable polymers, composites, fiberglass, ceramics, and clays.

### EXAMPLES

Objects and advantages of this disclosure are further illustrated by the following non-limiting examples, but the particular materials and amounts thereof recited in these examples, as well as other conditions and details, should not be construed to unduly limit this disclosure. Unless otherwise noted, all parts, percentages, ratios, etc. in the Examples and the rest of the specification are by weight.

TABLE 1
Materials

| Desig- | | |
|---|---|---|
| nation | Description | Source |
| AMD | 0.46 mm (0.018 inch)-thick ultraviolet- | 3M Company, St. |
| 500-18 | stable polyurethane film, assembled as | Paul, MN, United |
| | described in Example 1 of U.S. Pat. No. | States |
| | 8,916,271 (Marx et al). | |
| BMS | Graphite prepreg, available under the | Cytec Engineered |
| 8-256 | designation BMS 8-256 TY4 CL2 Style | Materials, Tempe, |
| | 3K-70-PW | AZ, United States |
| F700-NC | Mold release agent, commercially | Henkel AG & Co. |
| | available under the trade designation | KGaA, Düsseldorf, |
| | LOCTITE FREKOTE 700-NC | Germany |
| HMDSO | Hexamethyldisiloxane | Millipore Sigma, St. |
| | | Louis, MO, United |
| | | States |
| M120 | Carbon black pigment, commercially | Cabot Corporation, |
| | available under the designation | Boston, MA. United |
| | MONARCH 120 | States |
| THV 500 | 0.127 mm (0.005 inch) | 3M Company |
| | fluorothermoplastic tetrafluoroethylene, | |
| | hexafluoropropylene, and vinylidene | |
| | fluoride (THV) film, commercially | |
| | available under the trade designation | |
| | DYNEON THV 500 | |
| THV 610 | 0.127 mm (0.005 inch) | 3M Company |
| | fluorothermoplastic tetrafluoroethylene, | |
| | hexafluoropropylene, and vinylidene | |
| | fluoride (THV) film, commercially | |
| | available under the trade designation | |
| | DYNEON THV 500 | |
| R-960 | Titanium dioxide pigment, | The Chemours |
| | commercially available under the trade | Company, |
| | designation TI-PURE R-960 | Wilmington, DE, |
| | | United States |
| RP-2220 | Clear two-part urethane repair paste, | 3M Company |
| | commercially available under the | |
| | designation 3M SCOTCH-WELD RP- | |
| | 2220 | |

### Test Preparation and Methods:

### Preparation of Fiber Reinforced Composite Panels

Fiber reinforced composite panels with the associated multilayer films were prepared by curing in an autoclave by the following process. A F700-NC treated aluminum panel was used as the tool surface. Against the tool surface was laid the polyurethane film as described in the examples with the polyurethane layer against the tool. Six plies of BMS 8-256 were laid against the backside of the protective polyurethane film and the panels were bagged and cured in an autoclave with a nominal temperature ramp rate of 2.8° C./min (5° F./min) to 177° C. (350° F.) and holding for 120 minutes at a pressure of 0.55 MPa (80 psi). The panels were cooled to room temperature before removal and debagging.

### Preparation of Nanostructured THV

A nanostructured surface was applied to a roll of 66 cm (26 inch) wide THV 500 and THV 610 films using a home-built plasma treatment system described in detail in U.S. Pat. No. 5,888,594 (David et al.) with some modifications. The width of the drum electrode was increased to 108 cm (42.5 inches) and the separation between the two compartments within the plasma system was removed so that all the pumping was carried out by means of the turbo-molecular pump operating at a process pressure of around 10 mTorr (0.133 Pa).

The THV 500 and THV 610 films were mounted within the chamber, wrapped around the drum electrode, and secured to the take up roll on the opposite side of the drum. The unwind and take-up tensions were maintained at 18 N (4 pounds) and 45 N (10 pounds) respectively. The chamber door was closed and the chamber pumped down to a base pressure of 0.0005 torr (0.067 Pa). For the plasma treatment, HMDSO and oxygen were introduced at a flow rate of 43 standard cm³/min and 750 standard cm³/min respectively, and the operating pressure was nominally at 10 mTorr (0.133 Pa). Plasma was turned on at a power of 7500 watts by applying rf power to the drum and the drum rotation initiated so that the film was fed at a speed of 1.52 meters/min (5 feet/min). The run was continued until the entire length of the film on the roll was completed.

### Color Measurement and Delta E (ΔE)

Color of the cured composite panels was characterized by L*a*b* measurement before and after exposure to 24 hours of accelerated weathering per ASTM G154 Cycle 3. “L*” represents darkness to lightness, with values ranging from 0 to 100; “a*” represents greenness to redness with values of −128 to +127; and “b*” represents blueness to yellowness also with values from −128 to +127. Delta E (ΔE) was calculated based on the difference between the initial and weathered L*a*b* measurements. Delta E (ΔE) represents the color difference or color change due to the weathering exposure. The equation for calculating the Delta E was:

ΔE=\sqrt{(L1−L2)²+(a1−a2)²+(b1−b2)²}

### Peel Adhesion Test

After the composite panels were cured and bonded together, the peel adhesion between the polyurethane and the fluoropolymer layer was measured by manually initiating a failure at the polyurethane/fluoropolymer interface. The polyurethane was cut into 1.27 cm (0.5 inch) strips and peeled at an angle of 90° relative to the panel and at a rate of 10.2 cm (4 inches) per minute. The average peel force was measured using a Sintech 2GL Tensile Test Machine.

### Example 1 (EX1)

AMD 500-18 was laminated to the nanostructured side of the THV 610 film by heating in an autoclave to 148° C. (300° F.) at 5.6° C./min (10° F./min) and holding for 30 min at 0.21 MPa (30 psi) to create a multilayered film with a semi-IPN polyurethane top layer and a THV 610 base layer with a nanostructured surface at the polyurethane/THV 610 interface. A fiber reinforced composite panel was then prepared as described in the “Preparation of Fiber Reinforced Composite Panels” section with the THV 610 in direct contact with the fiber reinforced composite.

### Example 2 (EX2)

AMD 500-18 was laminated to the nanostructured side of the THV 500 film by heating in an autoclave to 148° C. (300° F.) at 5.6° C./min (10° F./min) and holding for 30 minutes at 0.21 MPa (30 psi) to create a multilayered film with a semi-IPN polyurethane top layer and a THV 500 base layer with a nanostructured surface at the polyurethane/THV 500 interface. A fiber reinforced composite panel was then prepared as described in the “Preparation of Fiber Reinforced Composite Panels” section with the THV 500 in direct contact with the fiber reinforced composite.

### Example 3 (EX3)

A gray, reactive polyurethane paste was prepared by mixing 19.6 g of RP-2220, 0.39 g of R-960, and 0.01 g M120 in a Hauschild Model DAC 400 FVZ SpeedMixer at 2500 rpm for 60 seconds. The reactive mixture was coated onto the nanostructured surface of the THV 610 film at a thickness of 0.46 mm (0.018 inch) and allowed to cure at room temperature for two hours then post-cured at 82° C. (180° F.) for one hour to create a multilayered film with a crosslinked polyurethane top layer and nanostructured THV 610 base layer. A fiber reinforced composite panel was then prepared as described in the “Preparation of Fiber Reinforced Composite Panels” section with the THV 610 in direct contact with the fiber reinforced composite.

### Example 4 (EX4)

A gray, reactive polyurethane paste was prepared by mixing 19.6 g of RP-2220, 0.39 g of R-960, and 0.01 g M120 in a Hauschild Model DAC 400 FVZ SpeedMixer at 2500 rpm for 60 seconds. The reactive mixture was coated onto the nanostructured surface of the THV 500 film at a thickness of 0.38 mm (0.015 inch) and allowed to cure at room temperature for two hours then post-cured at 82° C. (180° F.) for one hour to create a multilayered film with a crosslinked polyurethane top layer and nanostructured THV 500 base layer. A fiber reinforced composite panel was then prepared as described in the “Preparation of Fiber Reinforced Composite Panels” section with the THV 500 in direct contact with the fiber reinforced composite.

### Comparative Example 1 (CE1)

A fiber reinforced composite panel with AMD 500-18 as the top layer was prepared as described in the “Preparation of Fiber Reinforced Composite Panels” section.

### Comparative Example 2 (CE2)

AMD 500-18 was laminated to the non-treated side of the THV 610 film by heating in an autoclave to 148° C. (300° F.) at 5.8° C./min (10° F./min) and holding for 30 min at 0.21 MPa (30 psi) to create a multilayered film with a semi-IPN polyurethane top layer and a THV 610 base layer. A fiber reinforced composite panel was then prepared as described in the “Preparation of Fiber Reinforced Composite Panels” section with the THV 610 in direct contact with the fiber reinforced composite.

### Comparative Example 3 (CE3)

AMD 500-18 was laminated to the non-treated side of the THV 500 film by heating in an autoclave to 148° C. (300° F.) at 5.8° C./min (10° F./min) and holding for 30 min at 0.21 MPa (30 psi) to create a multilayered film with a semi-IPN polyurethane top layer and a THV 500 base layer. A fiber reinforced composite panel was then prepared as described in the “Preparation of Fiber Reinforced Composite Panels” section with the THV 500 in direct contact with the fiber reinforced composite.

Examples 1-4 and Comparative Examples 1-3 underwent Color Measurement and Delta E (ΔE) testing, and the results are represented in Table 2. Examples 1-2 and Comparative Examples 2-3 underwent Peel Adhesion Testing, and the results are represented in Table 3.

TABLE 2
Color Measurement and Delta E (ΔE) Results

| | | | Surface | | | | | | | |
|---|---|---|---|---|---|---|---|---|---|---|
| | | | Treatment at | Before | | | After | | | |
| | Polyurethane | | PU/fluoropolymer | Weathering | | | Weathering | | | |
| | (PU) | Fluoropolymer | interface | L* | a* | b* | L* | a* | b* | ΔE |
| CE1 | AMD 500-18 | None | Not Applicable | 52.77 | −1.51 | −3.81 | 48.44 | −3.55 | 19.95 | 24.2 |
| CE2 | AMD 500-18 | THV 610 | None | 54.40 | −1.40 | −3.88 | 53.64 | −1.58 | −2.94 | 1.2 |
| CE3 | AMD 500-18 | THV 500 | None | 54.54 | −1.46 | −4.01 | 53.37 | −1.71 | −2.96 | 1.6 |
| EX1 | AMD 500-18 | THV 610 | Nanostructured | 54.07 | −1.49 | −4.00 | 53.96 | −1.64 | −3.06 | 1.0 |
| | | | plasma | | | | | | | |
| EX2 | AMD 500-18 | THV 500 | Nanostructured | 54.28 | −1.50 | −4.07 | 53.48 | −1.74 | −2.97 | 1.4 |
| | | | plasma | | | | | | | |
| EX3 | RP-2220 | THV 610 | Nanostructured | 57.66 | −1.33 | −1.96 | 57.33 | −0.76 | −2.22 | 0.7 |
| | | | plasma | | | | | | | |
| EX4 | RP-2220 | THV 500 | Nanostructured | 57.68 | −1.17 | −1.92 | 57.30 | −0.79 | −2.11 | 0.6 |
| | | | plasma | | | | | | | |

TABLE 3
Peel Adhesion Test Results

| | | | Fluoropolymer | Average 90° |
|---|---|---|---|---|
| | | | Surface Treatment | Peel Adhesion |
| Sam- | | Fluoro- | at PU/Fluoro- | N/m |
| ple | Polyurethane | polymer | polymer Interface | (lb/in) |
| CE2 | AMD 500-18 | THV 610 | None | 105 (0.6) |
| CE3 | AMD 500-18 | THV 500 | None | 105 (0.6) |
| EX1 | AMD 500-18 | THV 610 | Nanostructured | 2959 (16.9) |
| | | | plasma | |
| EX2 | AMD 500-18 | THV 500 | Nanostructured | 2609 (14.9) |
| | | | plasma | |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

What is claimed is:

1. A multilayer film comprising:
a top layer comprising a polyurethane network and having an exposed major surface;
a barrier layer comprising a fluoropolymer and having opposed first and second major surfaces, wherein the first major surface is modified by a surface treatment and wherein the top layer is disposed on the first major surface.

2. The multilayer film of claim 1, wherein the top layer directly contacts the first major surface.

3. The multilayer film of claim 1, wherein the polyurethane network comprises a semi-interpenetrating network.

4. The multilayer film of claim 3, wherein the semi-interpenetrating network comprises:
a polymer network selected from the group consisting of urethane acrylate polymer networks, urethane/urea acrylate polymer networks and urea acrylate polymer networks; and
a linear or branched polymer that is a thermoplastic polymer selected from the group consisting of thermoplastic polyurethanes, thermoplastic polyurethane/polyureas, thermoplastic polyureas, and combinations thereof.

5. The multilayer film of claim 1, wherein the surface treatment comprises a nanostructured plasma treatment.

6. The multilayer film of claim 1, wherein the fluoropolymer comprises a copolymer of tetrafluoroethylene, hexafluoropropylene, and vinylidene fluoride.

7. The multilayer film of claim 1, wherein the barrier layer and the top layer are both colored, the barrier layer having a color distinct from that of the top layer.

8. A composite assembly comprising:
a top layer having an exposed major surface and comprising a polyurethane network;
a barrier layer comprising a fluoropolymer and having opposed first and second major surfaces, wherein the first major surface is modified by a surface treatment; and
a substrate, wherein the first major surface of the barrier layer faces the top layer and the second major surface of the barrier layer faces the substrate.

9. The composite assembly of claim 8, wherein the polyurethane network comprises a semi-interpenetrating polyurethane network.

10. The composite assembly of claim 8, wherein the top layer directly contacts the first major surface and the substrate directly contacts the second major surface.

11. The composite assembly of claim 8, wherein the surface treatment comprises a nanostructured plasma treatment.

12. The composite assembly of claim 8, wherein the substrate comprises a curable substrate.

13. The composite assembly of claim 12, wherein the curable substrate comprises a fiber-reinforced prepreg.

14. A method of making a multilayer film comprising:
modifying a first major surface of a barrier layer comprising a fluoropolymer; and
coating a curable polyurethane onto the first major surface; and
curing the curable polyurethane.

15. The method of claim 14, wherein modifying the first major surface comprises applying a nanostructured plasma treatment.

16. The method of claim 14, wherein the curable polyurethane, once cured, comprises a semi-interpenetrating network.

17. The method of claim 16, wherein the semi-interpenetrating network comprises:
a polymer network selected from the group consisting of urethane acrylate polymer networks, urethane/urea acrylate polymer networks and urea acrylate polymer networks; and
a linear or branched polymer that is a thermoplastic polymer selected from the group consisting of thermoplastic polyurethanes, thermoplastic polyurethane/polyureas, thermoplastic polyureas, and combinations thereof.

18. The method of claim 14, wherein the curable substrate comprises a fiber-reinforced prepreg.

19. The method of claim 14, wherein the curable substrate is an aircraft component.
